(19) United States
(12) Patent Application Publication
(10) Pub. No.: US 2009/0240773 A1
(43) Pub. Date: Sep. 24, 2009

(54) Information processing apparatus, data sharing method, and data sharing program

(75) Inventor: Michito Kakie, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/289,470

(22) Filed: Oct. 28, 2008

(30) Foreign Application Priority Data
Mar. 21, 2008 (JP) 2008-073820

(51) Int. Cl. G06F 15/16; H04M 1/56

(52) U.S. Cl. 709/205; 379/142.15

(57) ABSTRACT

Information processing apparatus that can improve the convenience of data sharing. A portable apparatus has a voice call function implemented by a voice call block and a data storage function implemented by a shared data storage block. A voice call destination information output block identifies the destination of a voice call, when the voice call block and the voice call function of the information processing apparatus start the voice call, and outputs voice call destination identification information identifying the voice call destination. Receiving the identification information output by the voice call destination information output block, an access control block judges whether the received identification information is included in access control information stored in an access control information storage block. If the voice call destination identification information is included in the access control information, the access control block permits the information processing apparatus to access the shared area through a network.

### CROSS-REFERENCE TO RELATED APPLICATIONS

This application is based upon and claims the benefits of priority from the prior Japanese Patent Application No. 2008-073820, filed on Mar. 21, 2008, the entire contents of which are incorporated herein by reference.

### BACKGROUND OF THE INVENTION

1. Field of the Invention

The present invention relates to information processing apparatuses, data sharing methods, and data sharing programs, and particularly to an information processing apparatus having a function to control access to a shared area and a data sharing method and a data sharing program for controlling access to the shared area.

2. Description of the Related Art

In one conventional use of the computer, distant users discuss the same document browsed on their computers while they are talking on the phone. In this type of use, the users can share a material by storing the material data in a shared area of the user's computer, a file server, or the like connected through a network. The shared area can be generated by a function of an operating system or application software (application) executed on the computer or the file server, for instance.

The users can also share a material by sending the material data by electronic mail or the like from one user to the computer of the other user. A disadvantage of this method is that each time the material is updated or added, the material data must be retransmitted by electronic mail or the like so that both users share the same data. Accordingly, the method of sharing the material data stored in the shared area is convenient because the users can update the material dynamically while they are talking.

One known method of allowing users to share a file while they are talking on the phone identifies both users and generates an area that can be accessed at the same time just by the identified users, automatically on a server (see Japanese Unexamined Patent Publication No. 2007-166018, for example).

The method disclosed in Japanese Unexamined Patent Publication No. 2007-166018, however, requires the server that can be connected from both users, and a large system is required to implement the method.

Since the user must use a telephone and a computer simultaneously, portability would be rather poor for outdoor use.

The conventional method is inconvenient also in the following point, for example: since the shared area is generated only while the users are talking, either user cannot generate an area to be shared or prepare data in the area, when necessary in a non-voice-call period.

### SUMMARY OF THE INVENTION

In view of the foregoing, it is an object of the present invention to provide an information processing apparatus, a data sharing method, and a data sharing program by which data can be shared conveniently.

To accomplish the above object, according to the present invention, there is provided an information processing apparatus that can be connected to a peer information processing apparatus through a network. This information processing apparatus includes the following elements: a voice call block which performs a voice call by phone; a shared data storage block which provides a shared area for storing data to be shared with the peer information processing apparatus; an access control information storage block which stores access control information defining the peer information processing apparatus permitted to access the shared area through the network, by associating it with voice call destination identification information for identifying at least the destination of the voice call; a voice call destination information output block which outputs the voice call destination identification information in accordance with the destination of the voice call when the voice call block starts the voice call; and an access control block which performs judgment of whether the voice call destination identification information output by the voice call destination information output block is included in the access control information stored in the access control information storage block and, if the voice call destination identification information is included, permits the peer information processing apparatus corresponding to the voice call destination identification information to access the shared area through the network.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the basic concept of information processing apparatuses of embodiments.

FIG. 2 shows the system structure of a first embodiment.

FIG. 3 shows the hardware structure of a portable apparatus of the first embodiment.

FIG. 4 is a block diagram showing the functions of the portable apparatus of the first embodiment.

FIG. 5 shows an example of the data structure of access control information in the first embodiment.

FIG. 6 shows an example of the data structure of an access permission table in the first embodiment.

FIG. 7 is a flowchart showing data sharing processing in the first embodiment.

FIGS. 8A and 8B are outlined diagrams showing how data is shared between the portable apparatuses of the first embodiment.

FIG. 9 shows the system structure of a second embodiment.

FIG. 10 shows the hardware structure of a portable apparatus of the second embodiment.

FIG. 11 is a block diagram showing the functions of the portable apparatus of the second embodiment.

FIG. 12 shows an example of the data structure of access control information in the second embodiment.

FIG. 13 is a flowchart showing data sharing processing in the second embodiment.

FIGS. 14A and 14B are outlined diagrams showing how data is shared between the portable apparatuses of the second embodiment.

FIG. 15 shows an example of the data structure of access control information in a third embodiment.

FIG. 16 shows an example of the data structure of an access permission table in the third embodiment.

FIG. 17 is a flowchart showing data sharing processing in the third embodiment.

FIG. 18 is an outlined diagram showing how data is shared between the portable apparatuses of the third embodiment.

### DESCRIPTION OF THE PREFERRED EMBODIMENTS

Embodiments will be described in detail below, with reference to the drawings. First, an outline of the embodiments will be described, and then each embodiment will be described in detail.

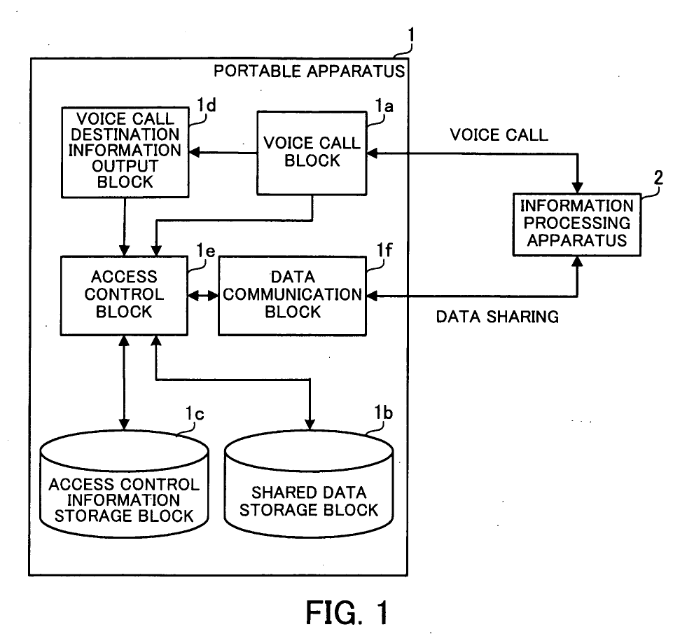

FIG. 1 shows the basic concept of information processing apparatuses of embodiments.

In the subsequent description of the embodiments, a portable apparatus 1 exemplifies the information processing apparatuses. The information processing apparatuses, however, are not limited to portable apparatuses and can be stationary apparatuses. The portable apparatus 1 shown in FIG. 1 is a small terminal which can store and process data in it and also enables data communication through a network and a voice call with another information processing apparatus or the like. In FIG. 1, the portable apparatus 1 controls access to a shared area for storing shared data, from an information processing apparatus 2 connected through a network. The portable apparatus 1 has a function to make a voice call with the information processing apparatus 2 or implements a voice call with a voice call terminal used by the user of the information processing apparatus 2. In the following description, the terminal for implementing a voice call with the portable apparatus 1 is referred to as a voice call destination terminal (including the information processing apparatus 2).

The portable apparatus 1 includes a voice call block 1a, a shared data storage block 1b, an access control information storage block 1c, a voice call destination information output block 1d, an access control block 1e, and a data communication block 1f.

The voice call block 1a is used to make a voice call by phone. The voice call block 1a implements a voice call between the user of the portable apparatus 1 and the user of a voice call destination terminal. When a voice call starts, the voice call block 1a outputs a voice call start notification including voice call status data to the voice call destination information output block 1d. If the portable apparatus 1 first issues a voice call request to the destination, the voice call status data includes information identifying the terminal specified as the voice call destination. If the portable apparatus 1 first receives a voice call request from the voice call destination, the voice call status data includes information identifying the voice call destination terminal, such as the telephone number, issued by the terminal at the voice call. When the voice call ends, the voice call block 1a outputs a voice call end notification to the access control block 1e.

The shared data storage block 1b provides a shared area for storing data to be shared with another information processing apparatus (the information processing apparatus 2 in FIG. 1).

The access control information storage block 1c stores access control information which defines an information processing terminal permitted to access the shared area through a network, by associating it with voice call destination identification information identifying at least the destination of the voice call by the voice call block 1a. The voice call destination identification information is a telephone number for a voice call using a public telephone network or an IP address for a voice call using a data communication network (voice call by internet protocol (IP) telephony), for example. With the voice call destination identification information, the voice call destination terminal can be identified.

When the voice call block 1a starts a voice call, the voice call destination information output block 1d identifies the voice call destination and outputs the voice call destination identification information. The voice call destination information output block 1d can detect the beginning of the voice call by receiving the voice call start notification output from the voice call block 1a. The voice call destination information output block 1d can also obtain voice call destination identification information from the voice call status data included in the voice call start notification.

Receiving the voice call destination identification information output from the voice call destination information output block 1d, the access control block 1e judges whether the received voice call destination identification information is included in the access control information stored in the access control information storage block 1c, and if the information is included, permits the information processing apparatus 2 corresponding to the voice call destination identification information to access the shared area through the network. When the voice call ends, the block prohibits the access. Now, the access control block 1e can detect the end of the voice call between the user of the portable apparatus 1 and the user of the information processing apparatus 2 by receiving the voice call end notification output from the voice call block 1a.

The access control block 1e also receives a request to access the shared area in the shared data storage block 1b, from the information processing apparatus 2 through the data communication block 1f. The access request is a read (data read) request, a write (data update) request, or a delete (data delete) request to the shared area, for example. The user of the portable apparatus 1 can specify appropriately which access request should be permitted. The access control block 1e permits an operation to the shared area in response to an access request from the information processing apparatus 2 permitted to access it during a voice call and outputs the result to the data communication block 1f.

The data communication block 1f receives a request to access the shared area in the shared data storage block 1b, from the information processing apparatus 2. The data communication block 1f outputs the access request to the access control block 1e.

Only during a voice call with a different information processing apparatus or voice call terminal, the portable apparatus 1 can generate in itself an area that can be shared with the user at the voice call destination. By storing desired data in the shared area, the user can share the data easily with the user at the voice call destination. Security against unauthorized access from the outside or the like is high because the user at the voice call destination becomes unable to access the shared area when the voice call ends. In addition, unlike the conventional system, since the shared area is generated not on the server but in the local terminal, high convenience is provided because the shared area can be processed in a non-voice-call period. Since the small portable apparatus 1 implements the data processing-storage function, the data communication function, and the voice call function, high portability is provided. In particular, the apparatus is useful when it is used outdoor or the like.

### First Embodiment

A first embodiment will now be described in detail with reference to figures.

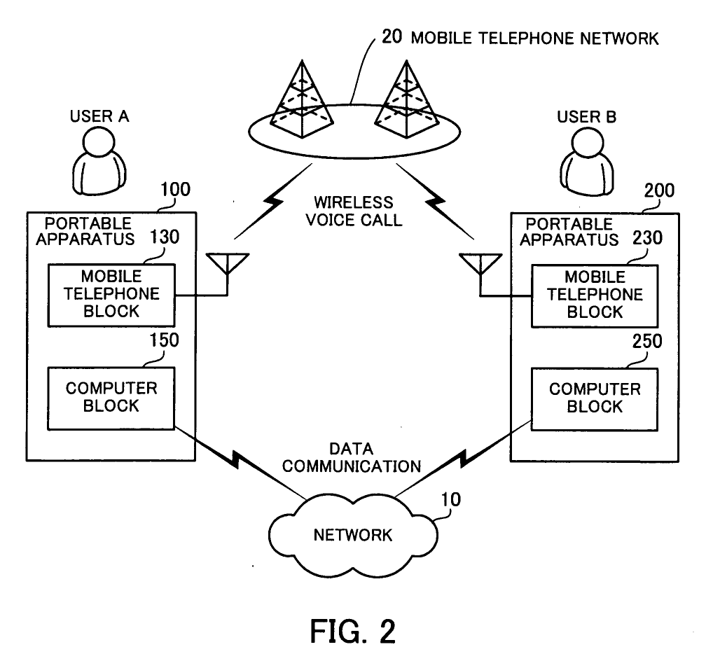

FIG. 2 shows the system structure of the first embodiment. A data sharing system shown in FIG. 2 allows data to be shared between portable apparatuses 100 and 200 while they are engaged in a voice call. The portable apparatuses 100 and 200 are used by users A and B respectively.

In the data sharing system of the first embodiment, the portable apparatuses 100 and 200 are connected to a network 10 by a wireless network, and IP communication through the network 10 is possible. The portable apparatuses 100 and 200 are connected also to a mobile telephone network 20 by a wireless channel.

The portable apparatus 100 includes a mobile telephone section 130 and a computer section 150. The mobile telephone section 130 and the computer section 150 are a single hardware resource implementing the function of a mobile telephone and a single hardware resource implementing the function of a general-purpose computer respectively, and they can operate as independent information processing sections. The single hardware resource here means a group of hardware, such as a central processing unit (CPU) and a random access memory (RAM) needed to configure a single information processing section.

The mobile telephone section 130 implements a voice call with a mobile telephone section 230 of the portable apparatus 200 through the mobile telephone network 20.

The computer section 150 implements data communication with a computer section 250 of the portable apparatus 200 through the network 10.

The mobile telephone section 230 and the computer section 250 of the portable apparatus 200 correspond to the mobile telephone section 130 and the computer section 150 respectively.

With the portable apparatuses 100 and 200, users A and B can talk by radio and can also send and receive data by IP communication.

In the data sharing system, a remote terminal to communicate with the portable apparatus 100 can be an information processing apparatus such as a general-purpose computer. In that case, the remote terminal and the network 10 may be connected either by radio or by wire. The remote terminal may not necessarily have both the voice call function by phone and the information processing function implemented in the single housing.

The hardware structure of the portable apparatus 100 will be described next. The portable apparatus 100 will be described in detail below, and the portable apparatus 200 can be implemented by the same structure as the portable apparatus 100.

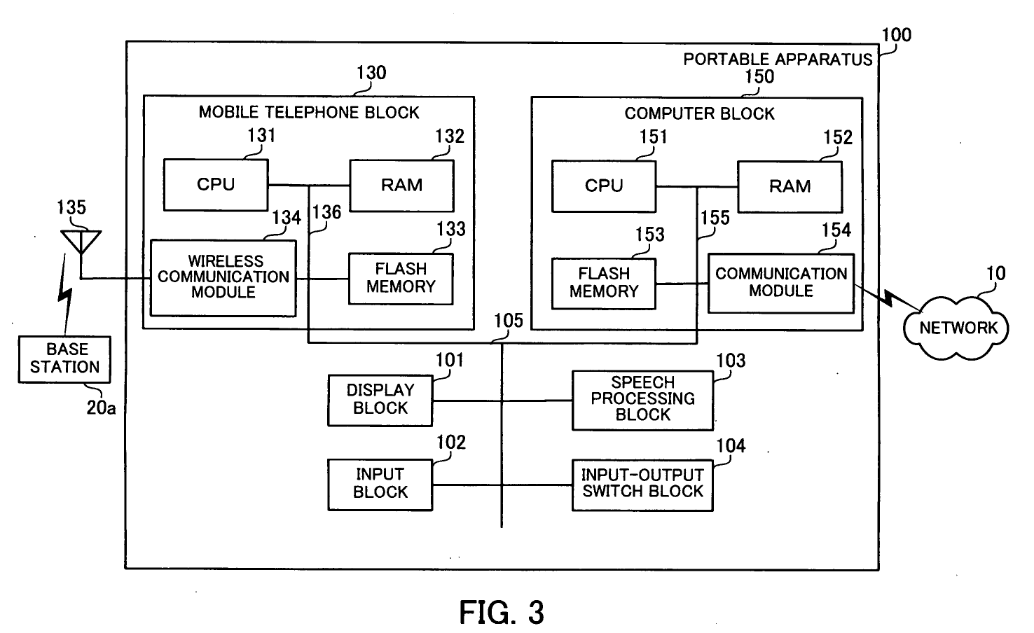

FIG. 3 shows the hardware structure of the portable apparatus 100 of the first embodiment. The portable apparatus 100 includes a display section 101, an input section 102, a speech processing section 103, an input-output switch section 104, the mobile telephone section 130, and the computer section 150. The sections in the portable apparatus 100 are connected mutually by a bus 105.

The display section 101 is a monitor for displaying an image as instructed by the CPU of each section. For example, a liquid crystal monitor is used as the display section 101.

The input section 102 makes input to the computer section 150 or the mobile telephone section 130. For example, a keyboard or a pointing device is used as the input section 102.

The speech processing section 103 is connected to a microphone, which is not shown, and performs speech input to the computer section 150 or performs speech input in a voice call by the mobile telephone section 130. The speech processing section 103 is connected to a speaker, which is not shown, and performs speech output from the computer section 150 or performs speech output in a voice call by the mobile telephone section 130.

The input-output switch section 104 switches the target of operation between the computer section 150 and the mobile telephone section 130. With the switching operation, the output source of the display section 101 and the speech processing section 103 can be changed. Likewise, the input destination of the input section 102 and the speech processing section 103 can be changed. By controlling a switch (not shown) disposed on the portable apparatus 100, for example, the user can specify the execution of the switching operation to the input-output switch section 104.

The hardware structure of the mobile telephone section 130 will be described next.

The whole of the mobile telephone section 130 is controlled by a CPU 131. The CPU 131 is connected to a RAM 132, a flash memory 133, and a wireless communication module 134 via a bus 136. An antenna 135 is connected to the wireless communication module 134.

The RAM 132 temporarily stores at least a part of an application program and an operating system (OS) to be executed by the CPU 131. The RAM 132 also stores a variety of data that would be needed in the processing by the CPU 131.

The flash memory 133 stores the OS and the application program for the mobile telephone section 130. The flash memory 133 also stores a variety of data that would be needed in the processing by the CPU 131.

The wireless communication module 134 includes a radio frequency (RF) circuit for wireless communication, a modulation-demodulation circuit for a signal to be sent and received, and the like. The mobile telephone section 130 enables a voice call with an information processing device such as another mobile telephone, by wireless communication with a base station 20a through the wireless communication module 134 and the antenna 135.

The hardware structure of the computer section 150 will be described next.

The whole of the computer section 150 is controlled by a CPU 151. The CPU 151 is connected to a RAM 152, a flash memory 153, and a communication module 154 through a bus 155.

The RAM 152 temporarily stores at least a part of an application program (application) and an OS to be executed by the CPU 151. The RAM 152 also stores a variety of data that would be needed in the processing by the CPU 151.

The flash memory 153 stores the OS and the application program for the computer section 150. The flash memory 153 also stores a variety of data that would be needed in the processing by the CPU 151.

The communication module 154 includes an RF processing section of a wireless LAN interface, a signal modulator-demodulator, and the like, for instance, and allows data transmission and reception with an information processing device such as another computer through the network 10. In the first embodiment, the communication module 154 performs wireless communication with the network 10, but a wired LAN interface to which a LAN cable can be connected may be disposed in the computer section 150 to be linked with the network 10, for example.

With this hardware structure, the processing functions of this embodiment can be implemented.

The functions of the portable apparatus 100 will be described next.

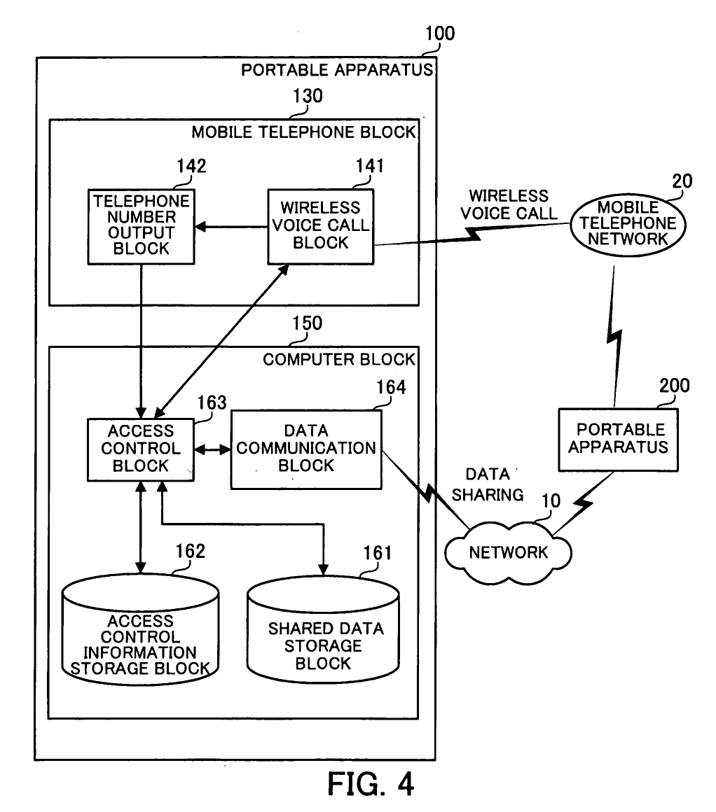

FIG. 4 is a block diagram showing the functions of the portable apparatus 100 of the first embodiment. The portable apparatus 100 includes a mobile telephone block 130 and a computer block 150.

The functions of the mobile telephone block 130 will be described first.

The mobile telephone block 130 includes a wireless voice call block 141 and a telephone number output block 142.

The wireless voice call block 141 implements a wireless voice call with the portable apparatus 200 through the mobile telephone network 20. When the wireless voice call starts, the wireless voice call block 141 outputs a voice call start notification to the telephone number output block 142. If the portable apparatus 100 issues a voice call request to the portable apparatus 200, the voice call start notification includes the telephone number of the portable apparatus 200 specified as the destination, as voice call status data. If a call is received from the portable apparatus 200, the voice call start notification includes the telephone number of the portable apparatus 200 obtained from the portable apparatus 200, as the voice call status data. When the wireless voice call ends, the wireless voice call block 141 outputs a voice call end notification to an access control block 163 of the computer block 150.

Receiving the voice call start notification output from the wireless voice call block 141, the telephone number output block 142 identifies the telephone number of the voice call destination (the portable apparatus 200) from the voice call status data included in the voice call start notification and outputs the telephone number to the access control block 163 of the computer block 150.

The functions of the computer block 150 will be described next.

The computer block 150 includes a shared data storage block 161, an access control information storage block 162, the access control block 163, and a data communication block 164.

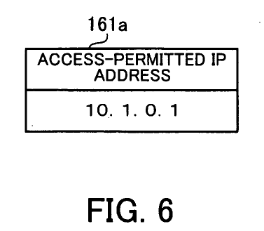

The shared data storage block 161 is provided in the flash memory 133. The shared data storage block 161 provides a shared area for storing data to be shared with the portable apparatus 200. The shared data storage block 161 stores an access permission table 161a for storing the IP address of an access request source which is permitted to access the shared area. No IP address is stored in the access permission table 161a in the non-voice-call period. For example, during a voice call with the portable apparatus 200, which is permitted to access the shared area, the access control block 163 stores the IP address of the portable apparatus 200. The access permission table 161a will be described in detail with reference to FIG. 6.

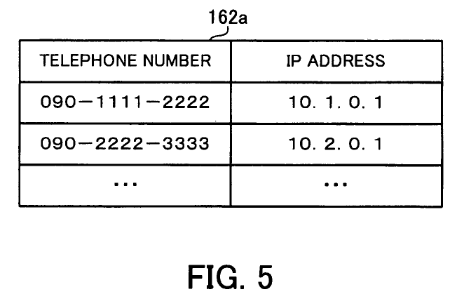

The access control information storage block 162 stores access control information 162a. The access control information 162a defines the portable apparatus 200, which is permitted to access the shared area in the shared data storage block 161 through the network 10, by its telephone number and an IP address corresponding to the telephone number. The access control information 162a will be described in detail with reference to FIG. 5.

The access control block 163 receives the telephone number of the portable apparatus 200 output from the telephone number output block 142. The access control block 163 checks whether the received telephone number is included in the access control information stored in the access control information storage block 162. If the telephone number of the portable apparatus 200 is found in the access control information, the access control block 163 stores the IP address of the portable apparatus 200, corresponding to the telephone number, in the access permission table in the shared data storage block 161. When an access request is made from an IP address stored in the access permission table, the access control block 163 permits the request source to access the shared area. When a voice call end notification is received from the wireless voice call block 141 while the portable apparatus 200 is allowed to access the shared area, the access control block 163 deletes the IP address from the access permission table. Then, access to the shared area from the request source having the IP address is prohibited.

The access control block 163 receives a request to access the shared area in the shared data storage block 161 from the data communication block 164. The access request here means a read (data read) request, a write (data update) request, or a delete (data delete) request to the shared area, for example. The user of the portable apparatus 100 can specify the operation right to indicate the access request to be permitted, as additional information of the access control information, in a table provided in the access control information storage block 162 and can store it there. Just when the portable apparatus 200, permitted to access during a voice call, sends an access request, the access control block 163 allows a corresponding operation to the shared area within the range of the operation right, and outputs the result to the data communication block 164.

The data communication block 164 receives a request to access the shared area in the shared data storage block 161 through the network 10, from the portable apparatus 200. The data communication block 164 outputs the access request to the access control block 163. The data communication block 164 also sends a response from the access control block 163 to the portable apparatus 200.

The access control information 162a stored in the access control information storage block 162 will be described next. The access control information is specified in advance by user A of the portable apparatus 100, and the information includes the telephone number of an information processing device to be permitted to access the shared area and an IP address corresponding to the telephone number. The information can be specified by using a special application for specifying the access control information, for instance.

FIG. 5 shows an example of the data structure of the access control information 162a in the first embodiment.

The access control information 162a includes a field indicating a telephone number and a field indicating an IP address. Items of information laid side by side are associated with each other and form access permission information concerning the shared area.

In the field indicating the telephone number, the telephone number of the information processing device at the voice call destination or of a voice call terminal used by the user using the information processing device is specified. In the field indicating the IP address, the IP address of another portable apparatus or of an information processing device such as a computer which is permitted to access the shared area is specified. If the information processing device that accesses the shared area does not have a telephone function, the telephone number of a voice call terminal disposed in the vicinity of the information processing device can be specified, so that the information processing device is permitted to access the shared area during a voice call between the portable apparatus 100 and the voice call terminal.

The access control information 162a includes such information that the telephone number is “090-1111-2222” and the IP address is “10.1.0.1”, for example. The information means that during a voice call with a portable apparatus or the like, identified by the telephone number “090-1111-2222”, access to the shared area through the network 10 is permitted when an access request is made from the IP address “10.1.0.1”.

The access permission table stored in the shared data storage block 161 will be described next.

FIG. 6 shows an example of the data structure of the access permission table 161a in the first embodiment. The access permission table 161a stores an IP address from which access to the shared area during a voice call is permitted by the access control block 163 in accordance with the access control information 162a.

The access permission table 161a has a field indicating an access-permitted IP address. In the field indicating the access-permitted IP address, the IP address of an access request source which is permitted to access the shared area in the shared data storage block 161 is specified.

In the access permission table 161a, an access-permitted IP address of “10.1.0.1” is specified, for example. This indicates that the portable apparatus or the like of the request source having an IP address of “10.1.0.1” is permitted to access the shared area in the shared data storage block 161.

Data sharing processing executed in the portable apparatus 100 having the elements and the data structures as described above will be described next in detail.

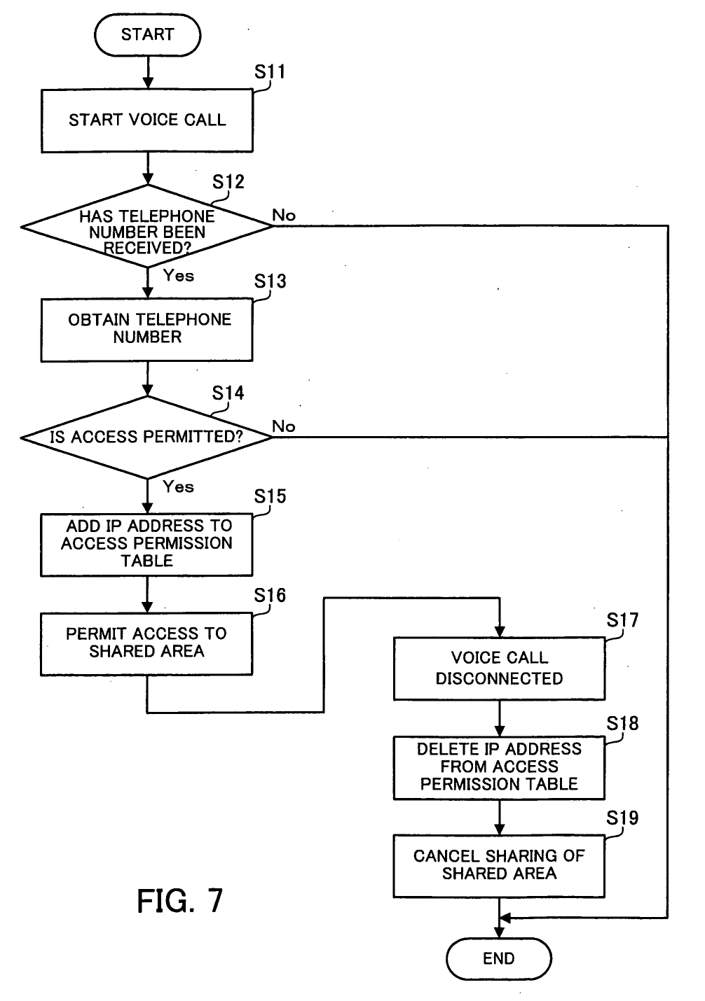

FIG. 7 is a flowchart showing the data sharing processing in the first embodiment. Individual steps shown in FIG. 7 will be described in numerical order. In FIG. 7, it is assumed that the portable apparatus 100 receives a voice call from the portable apparatus 200.

Step S11: The wireless voice call block 141 receives a call from the portable apparatus 200. A voice call starts between the users using both portable apparatuses.

Step S12: The wireless voice call block 141 outputs voice call status data concerning the voice call with the portable apparatus 200 to the telephone number output block 142. The telephone number output block 142 checks whether the received voice call status data includes the telephone number of the portable apparatus 200. If the telephone number is included, the telephone number output block 142 outputs the telephone number to the access control block 163, and the processing goes to step S13. If the telephone number is not included, the data sharing processing ends without performing the subsequent steps. Whether the voice call status data includes the telephone number depends on whether the portable apparatus 200 serving as the call source has issued the telephone number of the local terminal.

Step S13: The access control block 163 receives the telephone number of the portable apparatus 200 output from the telephone number output block 142.

Step S14: The access control block 163 checks whether the access control information 162a stored in the access control information storage block 162 includes the received telephone number. If the telephone number is found, the processing goes to step S15. If the telephone number is not found, the data sharing processing ends without performing the subsequent steps.

Step S15: The access control block 163 adds the IP address of the portable apparatus 200 corresponding to the received telephone number to the access permission table 161a in the shared data storage block 161.

Step S16: The portable apparatus 200 is now permitted to access the shared area in the shared data storage block 161, by a function of the computer block 250. Receiving an access request from the portable apparatus 200 through the data communication block 164, the access control block 163 permits the operation (read, write, or the like) specified in the request to access the shared area and returns the result of the operation.

Step S17: The voice call between the portable apparatuses 100 and 200 ends. The wireless voice call block 141 outputs a voice call end notification to the access control block 163.

Step S18: Receiving the voice call end notification output from the wireless voice call block 141, the access control block 163 deletes the IP address from the access permission table 161a stored in the shared data storage block 161.

Step S19: The portable apparatus 200 becomes unable to access the shared area in the shared data storage block 161.

As has been described above, the portable apparatus 200 can access the shared area stored in the portable apparatus 100 during the voice call between the portable apparatuses 100 and 200. In the description given above, whether the portable apparatus 200 is permitted to access the shared area is judged when the voice call starts by the wireless voice call block 141, but the permission to access the shared area may be judged when a request to access the shared area is received from the computer block 250 of the portable apparatus 200 during the voice call.

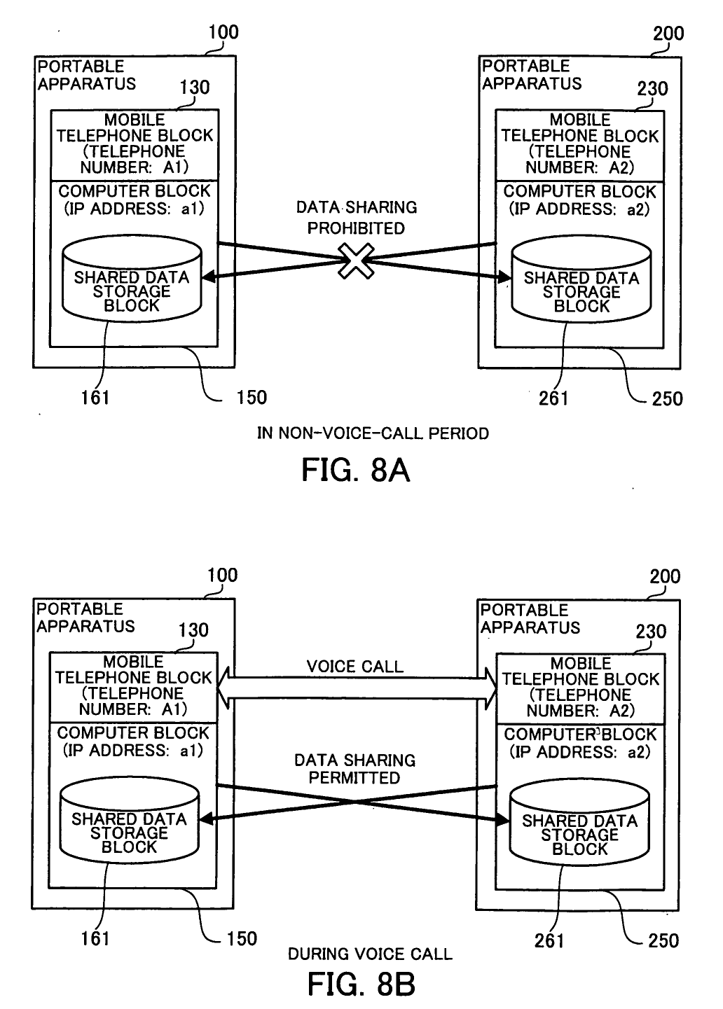

FIGS. 8A and 8B are outlined diagrams showing how data is shared between the portable apparatuses 100 and 200 of the first embodiment. The elements of the portable apparatuses 100 and 200 are the same as those shown with the same reference numerals in FIGS. 2 and 4, and a description of those elements will be omitted. Suppose the following about the portable apparatus 100: the mobile telephone block 130 has a telephone number “A1”, and the IP address of the computer block 150 is “a1”. Suppose the following about the portable apparatus 200: the mobile telephone block 230 has a telephone number “A2”, and the IP address of the computer block 250 is “a2”. Suppose also that the portable apparatuses 100 and 200 are permitted to access the shared data storage blocks 161 and 261 mutually during a voice call between them. In addition, suppose that each the mobile telephone blocks 130 and 230 is set up to issue its own telephone number to the voice call destination.

FIG. 8A shows a state in which the portable apparatuses 100 and 200 are not engaged in a voice call. In this state, each of the computer blocks 150 and 250 of the portable apparatuses 100 and 200 cannot access the shared area in the shared data storage block of the other portable apparatus.

FIG. 8B shows a state in which the portable apparatuses 100 and 200 are engaged in a voice call. If the call is received from the portable apparatus 200, the portable apparatus 100 obtains the telephone number “A2” issued by the mobile telephone block 230 of the portable apparatus 200. Then, the portable apparatus 100 permits the computer block 250 corresponding to the telephone number “A2” to access the shared area in the shared data storage block 161 from the IP address “a2”. If the call is originated from the portable apparatus 100 to the portable apparatus 200, it permits the computer block 250 to access the shared area in the shared data storage block 161 from the IP address “a2”, in accordance with the telephone number “A2” of the mobile telephone block 230 specified at the call origination.

If the portable apparatus 200 is permitted to read, for example, an icon of a data file placed in the permitted shared area is displayed on the display block, and the data file can be opened. If it is permitted to write, it can open and update a data file as well.

If the call is received from the portable apparatus 100, the portable apparatus 200 obtains the telephone number “A1” issued by the mobile telephone block 130 of the portable apparatus 100. Then, the portable apparatus 200 permits the computer block 150 corresponding to the telephone number “A1” to access to the shared area in the shared data storage block 261, from the IP address “a1”. When originating the call to the portable apparatus 100, the portable apparatus 200 permits the computer block 150 to access the shared area in the shared data storage block 261 from the IP address “a1”, in accordance with the telephone number “A1” of the mobile telephone block 130 specified at the call origination.

As has been described above, access to the shared area can be prohibited mutually in the non-voice-call period and can be permitted mutually during a voice call.

Only during a voice call with another communication terminal, the portable apparatus 200, or the like, the portable apparatus 100 described above can generate automatically in itself an area that can be shared with the user at the voice call destination. When data to be shared is stored in the shared area, the user can share the data with the user at the voice call destination. Because the user at the voice call destination becomes unable to access the shared area when the voice call ends, security is high. Unlike the conventional system, since the shared data is stored not on the server but in the local terminal, high convenience is provided because the data can be referenced and edited in the non-voice-call period. In addition, since the small portable apparatus 100 implements the data processing-storage function, the data communication function, and the voice call function, high portability is provided. In particular, the apparatus is useful when it is used outdoor or the like.

### Second Embodiment

A second embodiment will now be described in detail with reference to figures. The difference from the first embodiment described above will be mainly described, and a description of common features will be omitted.

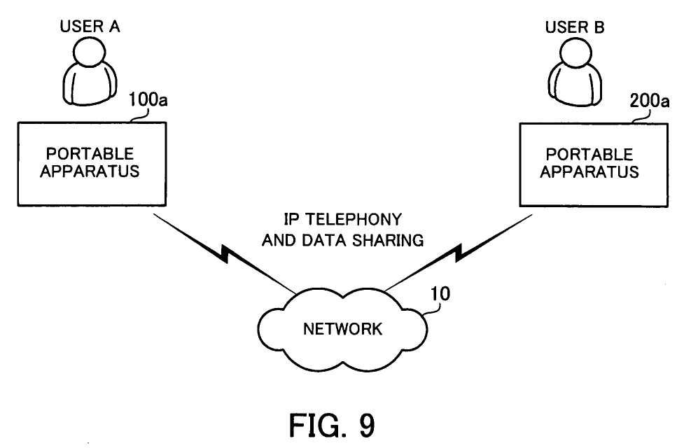

FIG. 9 shows the system structure of the second embodiment. A data sharing system shown in FIG. 9 allows data to be shared between portable apparatuses 100a and 200a while they are engaged in a voice call. The portable apparatuses 100a and 200a are used by users A and B respectively.

In the data sharing system of the second embodiment, the portable apparatuses 100a and 200a are connected to a network 10 by radio. In the data sharing system, the remote terminal of the portable apparatus 100a may be an information processing device such as a general-purpose computer. In that case, the remote terminal and the network 10 may be connected by wire, not by radio. The network 10 includes an IP telephone network. The portable apparatuses 100a and 200a implement a mutual voice call by sending and receiving voice over Internet protocol (VoIP) packet data through the network 10, for instance. This type of voice call is generally referred to as IP telephony. The portable apparatuses 100a and 200a also implement mutual data communication through the network 10.

With the portable apparatuses 100a and 200a, users A and B can talk on the phone while data is being sent and received by IP communication.

The hardware structure of the portable apparatus 100a will be described next. The portable apparatus 100a will now be described in detail. The portable apparatus 200a can be implemented by the same structure as the portable apparatus 100a.

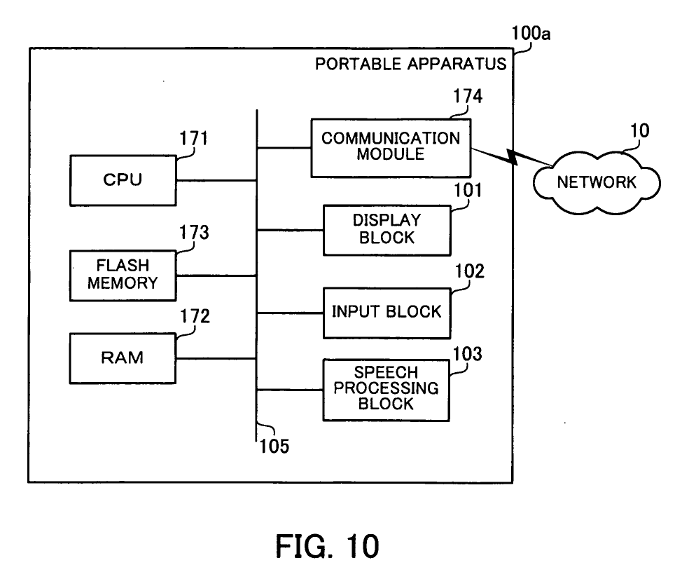

FIG. 10 shows the hardware structure of the portable apparatus 100a of the second embodiment. The whole of the portable apparatus 100a is controlled by a CPU 171. The CPU 171 is connected to a display section 101, an input section 102, a speech processing section 103, a RAM 172, a flash memory 173, and a communication module 174, through a bus 105. The display section 101, the input section 102, and the speech processing section 103 are the same as the elements denoted by the same reference numerals in FIG. 3, and a description of those elements will be omitted.

The RAM 172 temporarily stores at least a part of an application program and an OS to be executed by the CPU 171. The RAM 172 also stores a variety of data that would be needed in the processing by the CPU 171.

The flash memory 173 stores the OS and the application program for the portable apparatus 100a. The flash memory 173 also stores a variety of data that would be needed in the processing by the CPU 171.

The communication module 174 includes an RF processing section of a wireless LAN interface, a signal modulator-demodulator, and the like, and sends and receives data to and from another information processing device such as a computer through the network 10. The communication module 174 can also implement a voice call with the other information processing device by sending and receiving VoIP packet data, for instance.

In the second embodiment, the communication module 174 performs wireless communication with the network 10, but a wired LAN interface to which a LAN cable can be connected may be disposed to be linked with the network 10.

With this hardware structure, the processing functions of this embodiment can be implemented.

The functions of the portable apparatus 100a will be described next.

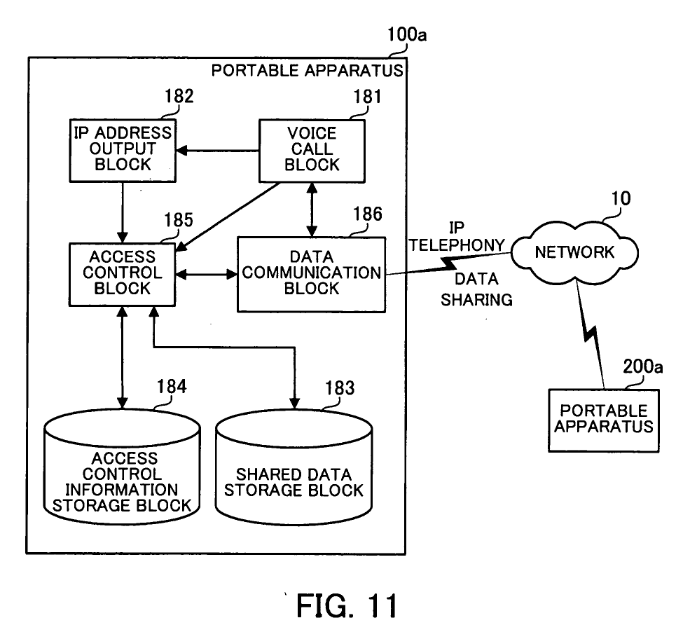

FIG. 11 is a block diagram showing the functions of the portable apparatus 100a of the second embodiment. The portable apparatus 100a includes a voice call block 181, an IP address output block 182, a shared data storage block 183, an access control information storage block 184, an access control block 185, and a data communication block 186.

The voice call block 181 implements a voice call with the portable apparatus 200a connected to the network 10, through the data communication block 186. When the voice call starts, the voice call block 181 outputs a voice call start notification to the IP address output block 182. If the portable apparatus 100a issues a voice call request to the portable apparatus 200a, the voice call start notification includes an IP address of the destination portable apparatus 200a as voice call status data. If the call comes from the portable apparatus 200a, the IP address of the portable apparatus 200a obtained from the portable apparatus 200a is included as voice call status data in the voice call start notification. When the voice call ends, the voice call block 181 outputs a voice call end notification to the access control block 185.

Receiving the voice call start notification output from the voice call block 181, the IP address output block 182 identifies the IP address of the voice call destination (the portable apparatus 200a) from the voice call status data included in the voice call start notification and outputs the IP address to the access control block 185.

The shared data storage block 183 provides a shared area for storing data to be shared with the portable apparatus 200a. The shared data storage block 183 stores also an access permission table for storing the IP address of an access request source which is permitted to access the shared area. The access permission table does not store an IP address in the non-voice-call period. During a voice call with the portable apparatus 200a, which is permitted to access the shared area, for example, the access control block 185 specifies the IP address of the portable apparatus 200a there.

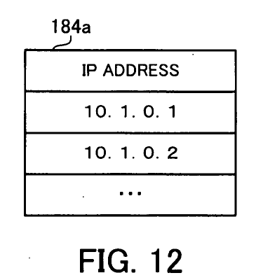

The access control information storage block 184 stores access control information. The access control information defines the portable apparatus 200a, which is permitted to access the shared area in the shared data storage block 183 through the network 10, by its IP address. The access control information will be described in detail with reference to FIG. 12.

The access control block 185 receives the IP address of the portable apparatus 200a output from the IP address output block 182. The access control block 185 then checks whether the received IP address is included in the access control information stored in the access control information storage block 184. If the IP address of the portable apparatus 200a is found in the access control information, the access control block 185 stores the IP address in the access permission table in the shared data storage block 183. Then, the access control block 185 permits access to the shared area from the IP address stored in the access permission table when an access request is made from the IP address. If a voice call end notification is received from the voice call block 181 while the portable apparatus 200a is permitted to access the shared area, the access control block 185 deletes the IP address from the access permission table. Then, access to the shared area, requested from the IP address is prohibited.

The access control block 185 also receives a request to access the shared area in the shared data storage block 183 from the data communication block 186. The access request here is a read request, a write request, or a delete request to the shared area, for instance. The user of the portable apparatus 100a can specify the operation right to indicate the access request to be permitted. Only when the portable apparatus 200a, permitted to access during a voice call, sends an access request, the access control block 185 allows a corresponding operation to the shared area within the range of the operation right, and outputs the result to the data communication block 186.

The data communication block 186 sends and receives voice packet data to be used in the processing by the voice call block 181, to and from the portable apparatus 200a. The data communication block 186 also receives from the portable apparatus 200a a request to access the shared area in the shared data storage block 183 through the network 10. The data communication block 186 outputs the access request to the access control block 185. The data communication block 186 sends a response from the access control block 185 to the portable apparatus 200a.

The access control information stored in the access control information storage block 184 will be described next. The access control information includes the telephone number of an information processing device which is to be permitted to access the shared area and the IP address corresponding to the telephone number, specified in advance by user A of the portable apparatus 100a. They can be specified by using a special application for specifying the access control information, for instance.

FIG. 12 shows an example of the data structure of the access control information in the second embodiment. The access control information 184a includes a field indicating an IP address.

In the field indicating the IP address, the IP address of another portable apparatus or an information processing device such as a computer which is permitted to access the shared area is specified.

The access control information 184a includes an IP address of “10.1.0.1”, for example. This indicates that while the portable apparatus 100a and a voice call destination terminal identified by an IP address of “10.1.0.1” are engaged in a voice call by IP telephony, the terminal is permitted to access the shared area.

The access permission table stored in the shared data storage block 183 indicates that the portable apparatus 200a or the like engaged in the voice call is permitted to access the shared area. The table has the same structure as the access permission table 161a shown in FIG. 6, and a description thereof will be omitted.

Data sharing processing executed by the portable apparatus 100a, having the elements and the data structure as described above, will be described next in detail.

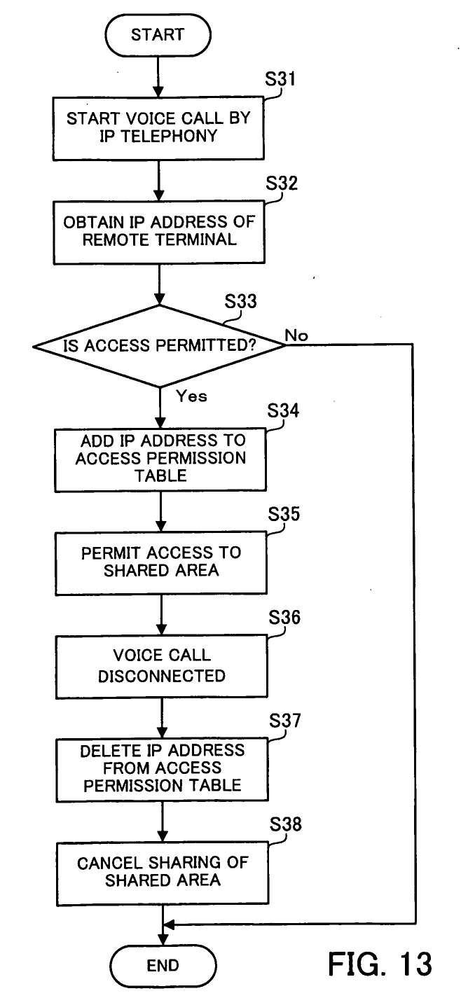

FIG. 13 is a flowchart showing the data sharing processing in the second embodiment. Individual steps shown in FIG. 13 will be described in numerical order. In FIG. 13, it is assumed that the portable apparatus 100a receives a voice call from the portable apparatus 200a.

Step S31: The voice call block 181 receives a call from the portable apparatus 200a through the data communication block 186, and the users using both portable apparatuses start talking.

Step S32: The voice call block 181 outputs voice call status data concerning the voice call with the portable apparatus 200a to the IP address output block 182. The IP address output block 182 identifies the IP address of the portable apparatus 200a from the received voice call status data and outputs the IP address to the access control block 185. The access control block 185 receives the IP address of the portable apparatus 200a output from the IP address output block 182.

Step S33: The access control block 185 checks whether the access control information 184a stored in the access control information storage block 184 includes the received IP address. If the address is found, the processing goes to step S34. If the address is not found, the data sharing processing ends without performing the subsequent steps.

Step S34: The access control block 185 adds the IP address of the portable apparatus 200a corresponding to the received IP address to the access permission table in the shared data storage block 183.

Step S35: The portable apparatus 200a is now permitted to access the shared area in the shared data storage block 183. If an access request is received from the portable apparatus 200a through the data communication block 186, the access control block 185 permits the operation specified in the request to access the shared area and returns the result of the operation.

Step S36: The voice call between the portable apparatuses 100a and 200a ends. The voice call block 181 outputs a voice call end notification to the access control block 185.

Step S37: Receiving the voice call end notification output from the voice call block 181, the access control block 185 deletes the corresponding IP address from the access permission table stored in the shared data storage block 183.

Step S38: The portable apparatus 200a becomes unable to access the shared area in the shared data storage block 183.

While the portable apparatuses 100a and 200a are engaged in a voice call by IP telephony, the portable apparatus 200a can perform an operation to the shared area stored in the portable apparatus 100a. In the description given above, whether the portable apparatus 200a is permitted to access the shared area is determined when the voice call block 181 starts the voice call. However, whether access to the shared area is permitted may be determined when the request to access the shared area is received from the portable apparatus 200a during the voice call.

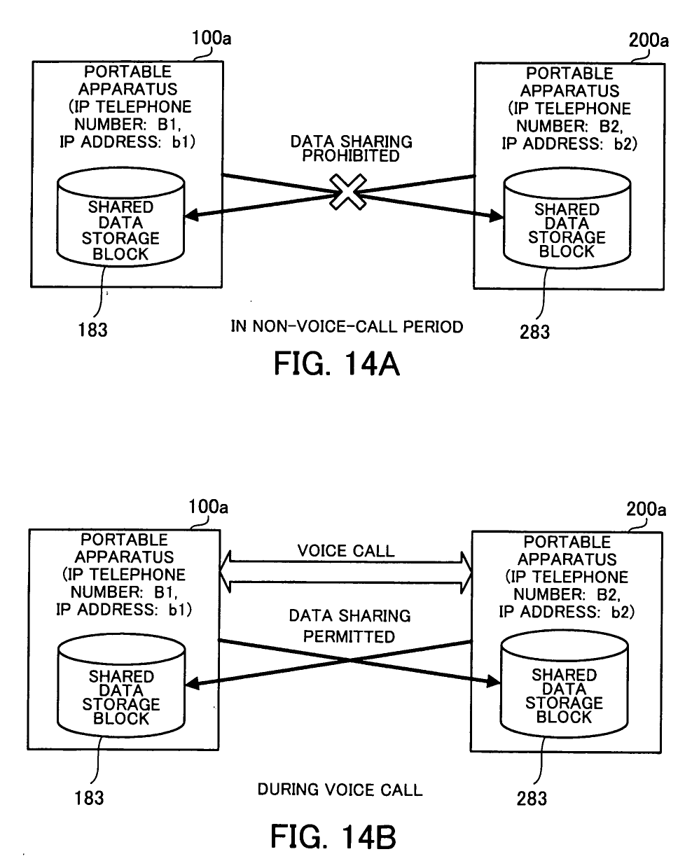

FIGS. 14A and 14B are outlined diagrams showing how data is shared between the portable apparatuses of the second embodiment. The structures of the portable apparatuses 100a and 200a are the same as those shown in FIGS. 9 and 11, with reference to the same reference numerals, and a description thereof will be omitted. It is assumed that, as for the portable apparatus 100a, the IP telephone number is “B1”, and the IP address is “b1”; as for the portable apparatus 200a, the IP telephone number is “B2”, and the IP address is “b2”; and the portable apparatuses 100a and 200a are permitted to access the shared data storage blocks 183 and 283 mutually during their voice call.

FIG. 14A shows the portable apparatuses 100a and 200a in the non-voice-call period. In this state, each of the portable apparatuses 100a and 200a cannot access the shared area in the shared data storage block of the other apparatus.

FIG. 14B shows the portable apparatuses 100a and 200a in their voice call. A case in which the portable apparatus 100a originates a call to the portable apparatus 200a will be described next. The portable apparatus 100a originates a call to the portable apparatus 200a by sending a connection request with the IP telephone number “B2” of the portable apparatus 200a specified to a call control server (not shown) of the network 10. The call control server converts the IP telephone number “B2” to the IP address of the portable apparatus 200a. A voice packet sent from the portable apparatus 100a includes the IP address and is transferred to the portable apparatus 200a in accordance with the IP address. The voice packet reaching the portable apparatus 200a includes the IP address “b1” of the originating portable apparatus 100a. The portable apparatus 200a obtains the IP address “b1” and permits access to the shared area in the shared data storage block 283 from the portable apparatus 100a. The portable apparatus 200a then sends a response voice packet to the portable apparatus 100a. The portable apparatus 100a obtains the IP address “b2” of the portable apparatus 200a from the voice packet and permits access to the shared area in the shared data storage block 183 from the portable apparatus 100a. When the portable apparatus 200a originates a call to the portable apparatus 100a, access to the shared area is permitted in the same way.

As described above, access to the shared area is disabled mutually in the non-voice-call period, and access to the shared area is permitted mutually during their voice call.

The portable apparatus 100a, described above, can generate automatically in itself an area that can be shared with the user at the voice call destination just during a voice call by IP telephony with another information processing apparatus, the voice call terminal 200a, or the like. By storing desired data in the shared area, the user can easily share the data with the user at the voice call destination. Because the remote user becomes unable to access the shared area when the voice call ends, security is high. Unlike the conventional system, the shared data is stored not on the server but in the local terminal. Therefore, high convenience is provided because the data can be referenced and edited in the non-voice-call period. In addition, since the small portable apparatus 100a implements the data processing-storage function, the data communication function, and the voice call function, high portability is provided. In particular, the apparatus is useful when it is used outdoor or the like.

### Third Embodiment

A third embodiment will now be described in detail with reference to figures. The third embodiment differs from the first embodiment in that the access control information 162a is expanded to provide different shared areas for different voice call destination terminals and use them separately. The system structure and the hardware structure and functions of a portable apparatus in the third embodiment are the same as the system structure in the first embodiment and the hardware structure and functions of the portable apparatus 100, shown in FIGS. 2, 3, and 4, and a description thereof will be omitted. In the third embodiment, an access control information storage block 162 provides a first shared area S1, a second shared area S2 . . . , and an n-th shared area Sn.

Access control information 162b stored in the access control information storage block 162 in the third embodiment will next be described.

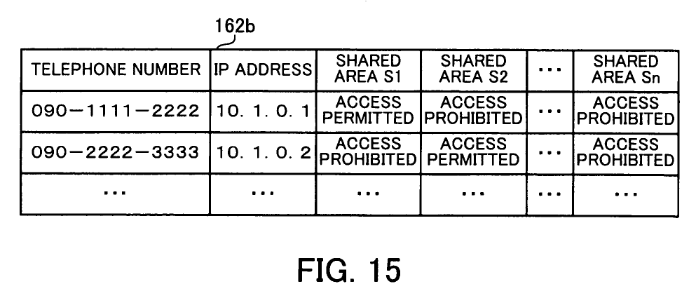

FIG. 15 shows an example of the data structure of the access control information 162b in the third embodiment. The access control information 162b includes a field indicating a telephone number, a field indicating an IP address, a field indicating the shared area S1, a field indicating the shared area S2, . . . , and a field indicating the shared area Sn. The fields laid in the same row are associated with one another, and the corresponding items form access permission information to the shared areas.

Information specified in the field indicating the telephone number and the field indicating the IP address is the same as the information specified in the corresponding fields in the access control information 162a shown in FIG. 5, and a description thereof is omitted. In the field indicating the shared area S1, whether access to the first shared area S1 is permitted is specified. In the field indicating the shared area S2, whether access to the second shared area S2 is permitted is specified. In the field indicating the shared area Sn, whether access to the n-th shared area Sn is permitted is specified.

Information specified in the access control information 162b indicates, for example, that the telephone number is “090-1111-2222”, the IP address is “10.1.0.1”, the shared area S1 is “accessible”, and the shared area S2 is “not accessible.” This means the following: While the portable apparatus or the like identified by the telephone number “090-1111-2222” is engaged in a voice call, access to the shared area through the network 10 is permitted in response to an access request from the IP address “10.1.0.1”; and the access request source is permitted to access the first shared area S1 and is not permitted to access the second shared area S2 or the n-th shared area Sn. Access to the third to (n−1)-th shared areas may or may not be permitted.

An access permission table 161b stored in a shared data storage block 161 will be described next.

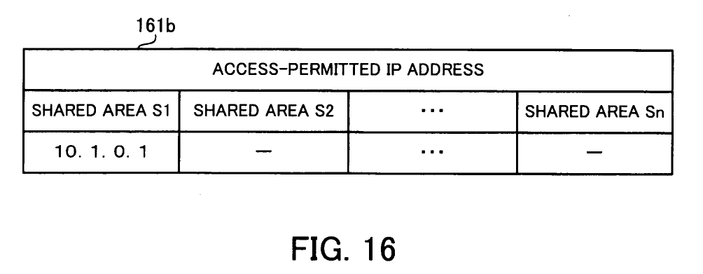

FIG. 16 shows an example of the data structure of the access permission table 161b in the third embodiment. The access permission table 161b stores the IP address from which access to the shared area is permitted during a voice call by the access control block 163 in accordance with the access control information 162b. The table differs from the table in the first embodiment in that the IP address from which access to each shared area is permitted is specified.

The access permission table 161b includes a field indicating an access-permitted IP address. The field indicating the access-permitted IP address further includes a field indicating the shared area S1, a field indicating the shared area S2, . . . , and a field indicating the shared area Sn. In the field indicating the shared area S1, the IP address of the access request source which is permitted to access the first shared area S1 is specified. In the field indicating the shared area S2, the IP address of the access request source which is permitted to access the second shared area S2 is specified. In the field indicating the shared area Sn, the IP address of the access request source which is permitted to access the n-th shared area Sn is specified.

The access permission table 161b includes information indicating, for example, that the access-permitted IP address (for the shared area S1) is “10.1.0.1”, the access permitted IP address (for the shared area S2) is “-”, and the access-permitted IP address (for the shared area Sn) is “-”. This means the following: Access to the first shared area S1 in the shared data storage block 161 is permitted from the portable apparatus or the like of the request source at the IP address “10.1.0.1”; and any shared area for which “-” is specified is not permitted to access from the outside.

Data sharing processing performed by a portable apparatus 100 having the elements and data structure as described above will be described next in detail.

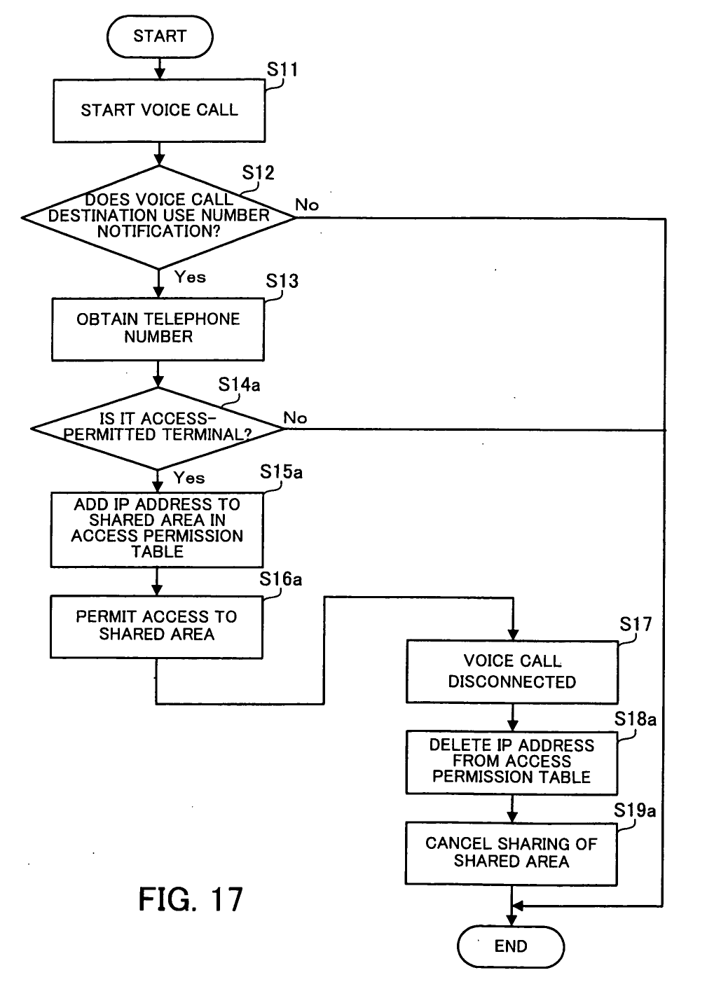

FIG. 17 is a flowchart showing the data sharing processing in the third embodiment. Individual steps shown in FIG. 17 will be described in numerical order. In FIG. 17, it is assumed that the portable apparatus 100 receives a voice call from the portable apparatus 200. Steps S11 to S13 and step S17 are the same as those having the same step numbers and described with reference to FIG. 7, and a description of the steps will be omitted.

Step S14a: An access control block 163 checks whether the access control information 162b stored in the access control information storage block 162 includes the received telephone number. If the telephone number is found, the processing goes to step S15a. If the telephone number is not found, the data sharing processing ends without performing the subsequent steps.

Step S15a: On the basis of the access control information 162b, the access control block 163 identifies the IP address of the portable apparatus 200 corresponding to the received telephone number and the shared area that is permitted to access from the request source at the IP address. The access control block 163 adds the identified IP address to the field of the identified shared area in the access permission table 161b of the shared data storage block 161.

Step S16a: The portable apparatus 200 is now permitted to access the shared area identified in step S15a, in the shared data storage block 161. When an access request is received from the portable apparatus 200 through a data communication block 164, the access control block 163 permits the operation specified in the request to access the shared area if the IP address of the terminal of the request source is included as an access-permitted IP address, and returns the result of the operation.

Step S18a: When a voice call end notification output from a wireless voice call block 141 is received, the access control block 163 deletes the IP address from the access permission table 161b stored in the shared data storage block 161.

Step S19a: The portable apparatus 200 becomes unable to access the shared area identified in step S15a, in the shared data storage block 161.

During the voice call between the portable apparatuses 100 and 200, the portable apparatus 100 permits the portable apparatus 200 to share a desired shared area by determining the area automatically among a plurality of shared areas.

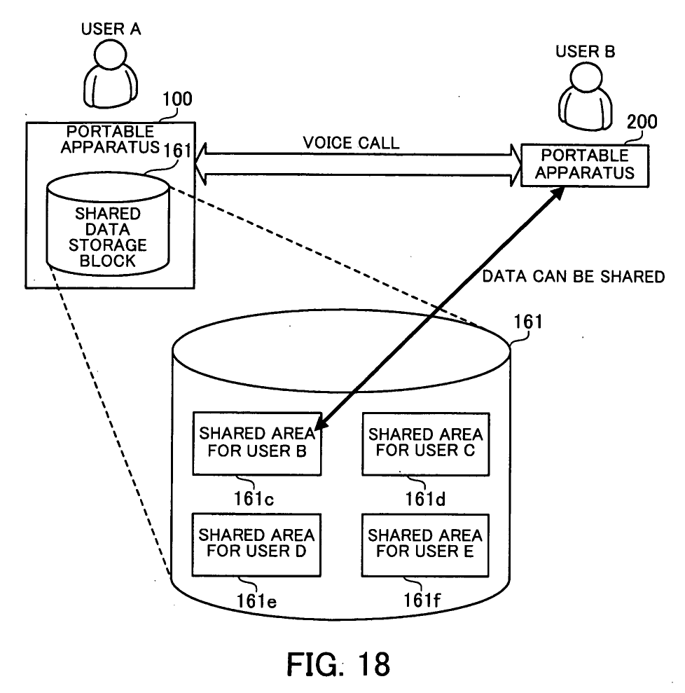

FIG. 18 is an outlined diagram showing how data is shared between the portable apparatuses of the third embodiment. The structures of the portable apparatuses 100 and 200 are the same as those having the same reference numerals and described with reference to FIGS. 2 and 4, and a description thereof will be omitted. The shared data storage block 161 of the portable apparatus 100 have different shared areas provided for different users identified from their different portable apparatuses. For example, the shared data storage block 161 has a shared area 161c for user B, a shared area 161d for user C, a shared area 161e for user D, and a shared area 161f for user E, and access requested at the IP address of the portable apparatus of a corresponding user is permitted while the portable apparatus is engaged in a voice call with the portable apparatus 100. User A can make these settings by using a special application for specifying access control information to be used by the portable apparatus 100, for instance.

When a call is received from the portable apparatus 200 used by user B, for example, the portable apparatus 100 permits the portable apparatus 200 to access the shared area 161c for user B just during the voice call. User B cannot access an area provided for a different user. When a call is received from a portable apparatus (not shown) used by user C, the portable apparatus of user C is permitted to access the shared area 161d for user C just during the voice call. When a call is received from a portable apparatus used by user D or user E, access permission is given in the same way.

By using different shared areas provided for different users, different materials and data to be shared with different users can be prepared separately in advance. This improves the convenience further, in comparison with the first embodiment. The data structures of the access control information 162b and the access permission table 161b described in the third embodiment can be applied also to the access control information 184a and the access permission table in the second embodiment. With the access control information 184a and the access permission table in the second embodiment, the same advantage as produced by the third embodiment can be obtained by specifying the IP address of each request source permitted to access each shared area.

Information processing apparatuses, data sharing methods, and data sharing programs of the present invention have been described according to the embodiments, but they are not limited to those described above, and an element can be replaced by any element having the same function. Any component or process can be added. Two or more structures (features) of the embodiments described above may be combined.

The processing functions described above can be implemented by a computer. In that case, a program describing the processing of the functions to be provided by the computer is provided. By executing the program on the computer, the processing functions of the portable apparatus 100 are implemented on the computer.

The program describing the processing can be recorded on computer-readable recording media. The computer-readable recording media include magnetic recording devices, optical discs, magneto-optical recording media, and semiconductor memories. The magnetic recording devices include HDDs, flexible disks (FDs), and magnetic tapes (MTs). The optical discs include digital versatile discs (DVDs), DVD-RAMs, a compact-disc read-only memories (CD-ROMs), CD-recordables (CD-Rs), and CD-rewritables (CD-RWs). The magneto-optical recording media include magnet-optical disks (MOs).

Portable recording media such as DVDs and CD-ROMs on which the program is recorded are sold to distribute the program, for instance. The program may be stored in a server computer to be transferred from the server computer to another computer through a network.

The computer for executing the program stores the program recorded on a portable recording medium or the program transferred from the server computer in its own memory, for instance. The computer reads the program from its own memory and executes processing in accordance with the program. The computer can also read the program directly from the portable recording medium to execute the processing in accordance with the program. The computer can also receive the program transferred successively from the server computer to execute the processing in accordance with the received program.

The information processing apparatuses, the data sharing methods, and the data sharing programs described above improve the convenience of data sharing.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An information processing apparatus that can be connected to a peer information processing apparatus through a network, the information processing apparatus comprising:
a voice call block which performs a voice call by phone;
a shared data storage block which provides a shared area for storing data to be shared with the peer information processing apparatus;
an access control information storage block which stores access control information defining the peer information processing apparatus permitted to access the shared area through the network, by associating it with voice call destination identification information for identifying at least the destination of the voice call;
a voice call destination information output block which outputs the voice call destination identification information in accordance with the destination of the voice call when the voice call block starts the voice call; and
an access control block which performs judgment of whether the voice call destination identification information output by the voice call destination information output block is included in the access control information stored in the access control information storage block and, if the voice call destination identification information is included, permits the peer information processing apparatus corresponding to the voice call destination identification information to access the shared area through the network.

2. The information processing apparatus according to claim 1, wherein the access control block prohibits the shared area from being accessed when the voice call by the voice call block ends.

3. The information processing apparatus according to claim 1, wherein the shared data storage block has a plurality of shared areas;
the access control information storage block stores the access control information specifying the voice call destination identification information corresponding to the peer information processing apparatus which is permitted to access each of the plurality of shared areas; and
the access control block makes the judgment in accordance with the access control information corresponding to each of the plurality of shared areas.

4. The information processing apparatus according to claim 1, comprising:
a first information processing block; and
a second information processing block which can operate in parallel with the first information processing block;
wherein:
the first information processing block implements the voice call block and the voice call destination information output block;
the second information processing block implements the access control information storage block and the access control block; and
the shared data storage block is connected to the second information processing block.

5. The information processing apparatus according to claim 1, wherein the voice call destination identification information is a telephone number of the destination of the voice call; and
as the access control information, address information on the network of the peer information processing apparatus to access the shared area and the telephone number are stored in association with each other.

6. The information processing apparatus according to claim 5, wherein the access control block receives the address information from the peer information processing apparatus requesting to access the shared area and judges whether to permit its access in accordance with the access control information, during the voice call by the voice call block.

7. The information processing apparatus according to claim 1, wherein the voice call block implements a function to make a voice call through the network by connecting to the network; and
the voice call destination identification information is address information on the network, of the destination of the voice call by the voice call block.

8. The information processing apparatus according to claim 1, wherein the information processing apparatus is a portable apparatus.

9. A data sharing method of an information processing apparatus that can be connected to a peer information processing apparatus through a network, the data sharing method comprising:
performing a voice call by phone by a voice call block;
providing a shared area for storing data to be shared with the peer information processing apparatus, by a shared data storage block;
outputting voice call destination identification information identifying a voice call destination in accordance with the destination of the voice call when the voice call block starts the voice call, by a voice call destination information output block; and
judging whether the voice call destination identification information output by the voice call destination information output block is included in access control information stored in an access control information storage block, the access control information defining the peer information processing apparatus permitted to access the shared area through the network, by associating it with the voice call destination identification information for identifying at least the destination of the call and, if the voice call destination identification information is included, permitting the peer information processing apparatus corresponding to the voice call destination identification information to access the shared area through the network, by an access control block.

10. A computer readable medium having stored thereon a data sharing program for controlling access to a shared area for storing data to be shared with a peer information processing apparatus, the shared area being provided by a shared data storage block in a computer, the data sharing program causing the computer to execute the steps of:
outputting voice call destination identification information identifying the destination of a voice call in accordance with the destination of the voice call when a voice call block of the computer starts the voice call;
judging whether the output voice call destination identification information is included in access control information defined by associating the peer information processing apparatus permitted to access the shared area through a network with the voice call destination identification information identifying at least the destination of the voice call; and
permitting the peer information processing apparatus corresponding to the voice call destination identification information to access the shared area through the network, if it is judged that the voice call destination identification information is included.
